(19) United States
(12) Patent Application Publication
(10) Pub. No.: US 2016/0296964 A1
(43) Pub. Date: Oct. 13, 2016

(54) POWDER COATING SYSTEM

(71) Applicant: AKEBONO BRAKE INDUSTRY CO., LTD., Chuo-ku, Tokyo (JP)

(72) Inventors: Tomomasa Osawa, Tokyo (JP); Yukio Iwata, Tokyo (JP); Jungo Masuda, Tokyo (JP); Yuya Niwano, Tokyo (JP)

(21) Appl. No.: 14/888,175

(22) PCT Filed: Nov. 26, 2014
(86) PCT No.: PCT/JP2014/005925

§ 371 Date: Oct. 30, 2015

(30) Foreign Application Priority Data
Nov. 26, 2013 (JP) 2013-244105
Oct. 1, 2014 (JP) 2014-203292

(51) Int. Cl. B05D 1/06; B05B 5/08; B05B 15/04

(52) U.S. Cl. CPC B05D 1/06; B05B 15/0431; B05B 5/082

(57) ABSTRACT

To provide an art that can perform masking more easily than the prior art, irrespective of a shape of a workpiece. A powder coating system that attaches powder to a workpiece includes a support tool that supports the workpiece, a robot arm which includes the support tool fixed thereto and is movable three-dimensionally, and a removing device that restrains adhesion of powder to a region not needing powder of the workpiece fixed to the robot arm, or removes powder adhering to a powder adhering region, by at least either one of ejection or suction.

### TECHNICAL FIELD

The present invention relates to a powder coating system, a powder coating method, a production method of a caliper, and a caliper.

### BACKGROUND ART

Coating is applied to industrial products for the purpose of rust prevention, decoration and the like. Regions not needing coating are present in industrial products, and masking is applied to the regions not needing coating so that coating materials do not adhere to the regions not needing coating. As the conventional masking method, there is the art which attaches a tape and a cap for masking to a region not needing coating, and detaches the tape and the cap for masking after coating. Further, for example, Patent Document 1 discloses an art of sucking a powder coating material on inner circumferential surfaces of a hub hole and a bolt hole of a wheel of a center cap type. Further, Patent Document 2 discloses a masking device that performs masking for a component to be coated by ejection of pressure air at the time of coating by a spray gun. The masking device described in Patent Document 2 ejects the pressure air that is regulated to a desired pressure to portions needing masking in the component to be coated through an air supply conduit, a rotary joint, a channel in a spindle and an inside of a work sheet, during an operation of the spray gun. Further, Patent Document 3 discloses a coating support device that supports a hollow object to be coated having a plurality of opening portions. The coating support device described in Patent Document 3 includes a fitting support portion which is a fitting support portion that supports an object to be coated by being fitted in one opening portion of a plurality of opening portions, and includes an air path in an inside, and air supply means that supplies air to a hollow portion of the object to be coated via the air path when or after a coating material is attached to the object to be coated.

### CITATION LIST

### Patent Literature

Japanese Patent Laid-Open No. 2002-346464

Japanese Utility Model Laid-Open No. 5-67361

Japanese Patent Laid-Open No. 2009-233510

### SUMMARY OF INVENTION

In the conventional masking method which attaches a tape and a cap for masking to a region not needing coating, and detaches the tape and the cap for masking after coating, attaching and detaching the tap and the cap for masking is needed. Therefore, an operation of masking is complicated, and there is a concern that the coating film on an object to be coated and the coating film adhering to the tape and the cap for masking may become integrated, and the coating film on the object to be coated may easily peel off when the tape and the cap for masking are detached. Meanwhile, there are the method for masking which sucks the coating material on the region not needing coating to restrain adhesion of the coating material to the region not needing coating, and the method for masking which ejects air to restrain adhesion of the coating material to the region not needing coating. In these masking methods, attaching and detaching the tapes and the caps for masking are not needed, and masking can be easily performed, as compared with the making method which uses a tape and a cap. However, in the art described in Patent Document 1, for example, the wheel which is a target of masking is fixed to the conveyer and is transported, the suction nozzle mounted to a robot moves, and sucks the coating material on the region not needing coating. Therefore, when the regions not needing coating are three-dimensionally exist in such a manner as to be on both surfaces, three surfaces and four surfaces, unlike the wheel, an industrial product to be the target of masking needs to be fixed again, and the operation is complicated. Further, masking is performed before a baking step of coating, and therefore, there is a concern that the coating material may be removed before the industrial product is fixed again.

Further, the art described in Patent document 2 needs to mount and hold a workpiece on a cylindrical work sheet, and the shape of the workpiece is limited. Further, in the art described in Patent document 3, the object to be coated is fixed to a hanger. Therefore, if removal of the coating material by suction is performed from an outside of the object to be coated, the suction device (for example, a suction nozzle) needs to be moved. Accordingly, when the shape of the object to be coated is complicated, and the region not needing coating exists three-dimensionally, a plurality of suction devices are installed, or the number of times of moving the suction device or the moving distance needs to be increased. Note that the above described problems exist in a powder attaching art, for example, as well as a powder coating art.

The present invention is made in the light of the above described problems, and has an object to provide an art of being able to perform masking more easily than the prior art irrespective of a shape of a workpiece.

In the present invention, in order to solve the above described problems, a workpiece is supported by a robot arm which is movable three-dimensionally, adhesion of powder to a region not needing powder in the workpiece is restrained, or powder adhering to a powder adhering region is removed.

In more detail, the present invention is a powder coating system that attaches powder to a workpiece, and includes a support tool that supports the workpiece, a robot arm that includes the support tool fixed thereto, and is movable three-dimensionally, and a removing device that restrains adhesion of powder to a region not needing powder in the workpiece supported by the support tool fixed to the robot arm, or removes powder adhering to a powder adhering region, by at least either one of ejection or suction.

In the present invention, the workpiece is supported by the support tool that is fixed to the robot arm which is movable three-dimensionally, and thereby the workpiece can be moved three-dimensionally. Therefore, the workpiece can be coated with powder while the workpiece is supported by the support tool which is fixed to the robot arm, and further, adhesion of the powder to the region not needing powder in the workpiece can be restrained, or the powder adhering to the powder adhering region can be removed, while the workpiece is supported by the support tool fixed to the robot arm. Further, the workpiece itself is movable three-dimensionally, and therefore, irrespective of the shape of the workpiece, redoing fixation of the workpiece (redoing support), and disposing a plurality of removing devices around the workpiece are not needed, irrespective of the shape of the workpiece. Therefore, restraint of adhesion of the powder to the region not needing powder, or removal of the powder adhering to the region not needing powder can be performed, more easily than in the prior art. Further, according to the powder coating system according to the present invention, three-dimensional movement of the workpiece is at will, and therefore, a difference between the film thickness of the powder adhering region and the film thickness of the region not needing powder can be gradually decreased. In other words, the film thickness can be made gradually thinner toward the region not needing powder from the powder adhering region.

Here, the removing device may include at least any one of a first ejection device that restrains adhesion of powder to the region not needing powder, by ejection of air, a second ejection device that removes powder adhering to the region not needing powder, by ejection of air, and a suction device that removes powder adhering to the region not needing powder, by suction. Thereby, restraint of adhesion of the powder to the region not needing powder, or removal of the powder adhering to the region not needing powder can be performed, by a negative pressure, or a positive pressure.

Further, the removing device includes a first ejection device that restrains adhesion of powder to the region not needing powder, by ejection of air, the workpiece includes an opening portion, and a recessed section that communicates with the opening portion, the support tool supports the recessed section of the workpiece from inside, and includes, in an inside, an air passage in which air passes, and the first ejection device may eject air via the air passage of the support tool, and restrain adhesion of powder to an inner surface of the opening portion, from inside of the workpiece.

The workpiece includes the recessed section, whereby the support tool can support the recessed section of the workpiece from inside by using the shape of the workpiece. Further, the recessed section and the opening portion of the workpiece communicate with each other, whereby adhesion of the powder to the inner surface of the opening portion can be restrained from inside of the workpiece by a positive pressure, by ejecting air via the air passage of the support tool.

Further, the support tool includes a fitting section that is fitted to a part of the recessed section of the workpiece in a hermetic state, the fitting section is configured by a conductive member and is electrically grounded, and the workpiece may have powder electrostatically attached thereto in an electrically grounded state. In the powder coating system according to the present invention, the support tool can easily grasp the workpiece, and adhesion of the powder to the region not needing powder can be restrained in the art of electrostatically attaching powder.

Further, the removing device includes a second ejection device that removes powder adhering to the region not needing powder, by ejection of air, and the second ejection device may insert an ejection nozzle into an opening portion of the workpiece to eject air, and remove powder adhering to an inner surface of the opening portion of the workpiece. By including the second ejection device, the powder adhering to the inner surface of the opening portion can be removed by a positive pressure.

Further, the removing device may include a suction ejection device that removes powder adhering to the region not needing powder by suction, and removes the powder adhering to the region not needing powder by ejection of air. Thereby, the powder adhering to the region not needing powder can be removed at the same time by suction and ejection of air. As the region not needing powder from which powder is removed with the suction ejection device, the inner surface of the hole from which the powder adhering thereto is removed by ejection of air, a bearing surface provided at an inlet of the hole, from which the powder adhering thereto is removed by suction, and the like are illustrated.

Further, the powder coating system according to the present invention further includes a powder coating device that attaches powder to the workpiece, and includes the removing device, and a heating device that bakes the powder adhering to the workpiece, to the workpiece, wherein the powder coating device and the heating device may be disposed within a range where the robot arm is movable. By disposing the powder coating device, and the heating device within the range where the robot arm is movable, powder coating can be performed more efficiently. Further, the removing device is provided in the powder coating device, and restraint of adhesion of the powder to the region not needing powder or removal of the powder adhering to the region not needing powder by suction and ejection can be performed efficiently.

Further, in the powder coating system according to the present invention, the workpiece is a caliper for a brake, and a cylinder may be provided at a part of the recessed section of the workpiece. The cylinders may be disposed to face each other, or the cylinder may be disposed at one side. The powder coating system according to the present invention can be favorably used in powder coating on the caliper body of the caliper for a brake, as one example.

Further, the present invention also can be defined as a powder coating method. Namely, the present invention is a powder coating method that attaches powder to a workpiece, and is a powder coating method including a powder removing step of supporting the workpiece by a support tool that is fixed to a tip end portion of a robot arm which is movable three-dimensionally, and supports the workpiece, and restraining adhesion of powder to a region not needing powder in the workpiece supported by the support tool fixed to the tip end portion of the robot arm, or removing powder adhering to a powder adhering region, by at least either one of ejection or suction.

Further, the powder coating method according to the present invention further includes a powder coating step of attaching powder to the workpiece, and a heating step of heating the workpiece to which the powder is attached, wherein the powder coating step, the powder removing step, and the heating step may be performed in a state in which the workpiece is supported by the robot arm via the support tool, by moving the robot arm three-dimensionally.

Further, the present invention also can be defined as a production method of a caliper. For example, the present invention is a production method of a caliper, and includes a powder coating step of supporting the caliper by a support tool that supports the caliper fixed to a tip end portion of a robot arm which is movable three-dimensionally, and attaching powder to the caliper, a powder removing step of restraining adhesion of powder to a region not needing powder of the caliper supported by the support tool, and removing powder adhering to a powder adhering region, by at least either one of ejection or suction, a heating step of baking the powder which is attached to the caliper, to the caliper, and a cooling step of cooling the caliper to which the powder is baked. The cooling step can be made, for example, a step that cools the caliper to which the powder is baked so as to be able to transfer the caliper to a subsequent step (for example, assembly or the like).

Further, the present invention also can be defined as a caliper. For example, the present invention is a caliper produced by the aforementioned powder coating system.

Further, in the caliper, a film thickness may be formed to be gradually thinner toward a region not needing powder from a powder adhering region. Thereby, occurrence of removal of coating or the like for which there is a concern in the conventional masking by a plug or a tape can be restrained.

According to the present invention, making can be performed more easily than in the prior art, irrespective of the shape of the workpiece.

### BRIEF DESCRIPTION OF DRAWINGS

FIG. 1 illustrates a view of a caliper body according to an embodiment, seen from an outside diameter side of a rotor.

FIG. 2 illustrates a view of the caliper body according to the embodiment, seen from an axial side of the rotor.

FIG. 3 illustrates a view of the caliper body according to the embodiment, seen from outside.

FIG. 4 illustrates a side view of the caliper body according to the embodiment.

FIG. 5 illustrates the caliper body according to the embodiment, seen from inside.

FIG. 6 illustrates a sectional view taken along A-A line in FIG. 4 of the caliper body according to the embodiment.

FIG. 7 illustrates a schematic configuration of a powder coating system according to the embodiment.

FIG. 8 illustrates a side view of a robot according to the embodiment.

FIG. 9 illustrates an enlarged view of a tip end portion of a robot arm according to the embodiment.

FIG. 10 illustrates a state in which a powder coating auxiliary tool is fixed to the tip end portion of the robot arm according to the embodiment.

FIG. 11 illustrates a surface on an outer side of the powder coating auxiliary tool according to the embodiment.

FIG. 12 illustrates a surface on an inner side of the powder coating auxiliary tool according to the embodiment.

FIG. 13A illustrates a sectional view in a position along line A-A in FIG. 4 in a case in which the powder coating auxiliary tool is connected to the caliper body according to the embodiment.

FIG. 13B illustrates a sectional view seen from a rotor axis side in a position along line B-B in FIG. 3 in the case in which the powder coating auxiliary tool is connected to the caliper body according to the embodiment.

FIG. 14 illustrates a coating device according to the embodiment.

FIG. 15 illustrates a coating treatment flow according to the embodiment.

FIG. 16 illustrates a sectional view of a vicinity of a boundary of a coated region and a region not needing coating.

FIG. 17 illustrates a manner of grasping a motor case as an industrial product.

FIG. 18 illustrates an example of a powder coating auxiliary tool according to another embodiment.

FIG. 19 illustrates a suction/ejection device according to another embodiment (state before pressing).

FIG. 20 illustrates the suction/ejection device according to the other embodiment (pressed state).

FIG. 21 illustrates a coating device according to another embodiment.

FIG. 22 illustrates an ejection nozzle according to another embodiment (ejection state).

### DESCRIPTION OF EMBODIMENTS

Next, an embodiment of the present invention will be described based on the drawings. In the embodiment, a case of using a powder coating system of the present invention in electrostatic coating of a caliper body of a disk brake of an automobile will be described as an example. However, a matter that will be described hereinafter is an illustration, and the present invention is not limited to a content of the embodiment which will be described hereinafter.

### Embodiment

### Caliper

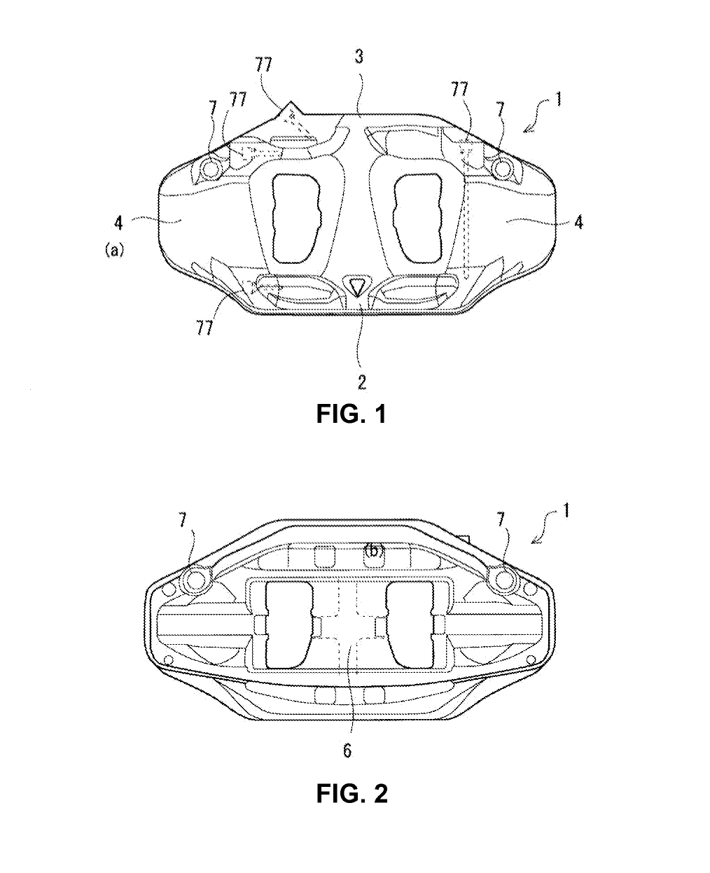

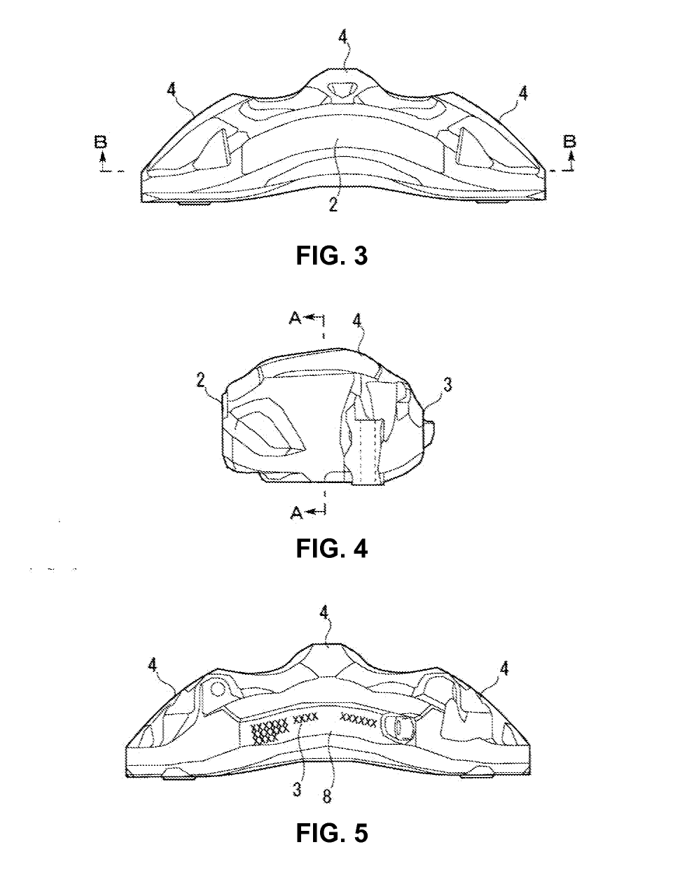

To begin with, a caliper body 1 (hereinafter, also simply called a caliper 1) of a disk brake of an automobile that is electrostatically coated will be described. FIG. 1 to FIG. 6 illustrate a caliper according to the embodiment. The caliper 1 (corresponding to a workpiece of the present invention) is to be used in an opposed piston type disk brake, and is an aluminum caliper integrally formed from an aluminum alloy. The caliper 1 includes a recessed portion 6 that accommodates a disk rotor which rotates with a wheel (Not illustrated. Hereinafter, also simply called a rotor), and a brake pad (not illustrated), and is widely opened. The caliper 1 is made by integrally forming a first body portion 2 and a second body portion 3 that are disposed at both sides (an outer side and an inner side) in an axial direction of the rotor, and a connecting portion 4 that connects both the body portions 2 and 3. In a first embodiment, six cylinders 5 in total are provided in the entire caliper 1, three for each of the first body portion 2 and the second body portion 3. The three cylinders 5 at the first body portion 2 side communicate with one another inside, and the three cylinders 5 at the second body portion 3 side also communicate with one another inside. Pistons (not illustrated) are respectively fitted into the respective cylinders 5, in an assembled state of the disk brake.

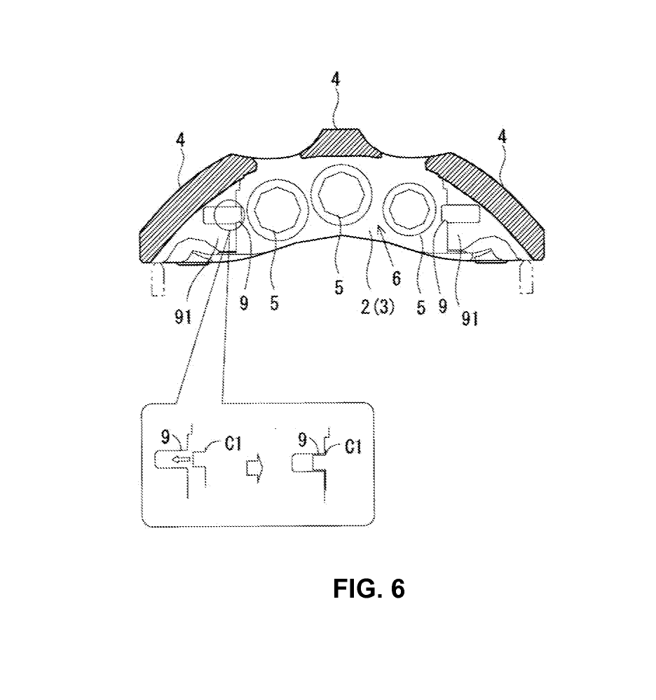

As illustrated in FIG. 1 and FIG. 2, mounting holes 7 for fixing the caliper 1 to a vehicle are provided in a close vicinity to both end portions of the second body portion 3. Further, the first body portion 2 and the second body portion 3 are provided with a plurality of sealable supply holes 77 that communicate with the cylinders 5 and supply oil to the cylinders 5. Further, as illustrated in FIG. 5, the second body portion 3 is provided with a printed surface 8 on which information for management (for example, a QR code for production management (registered trademark), a barcode, a serial number and the like) is printed. Further, as illustrated in FIG. 6, in an inner side surface of the recessed portion 6, at the connecting portion 4 sides (sides of ear portions (not illustrated) of the brake pads which are fixed to the caliper 1), of inner side surfaces of the first body portion 2 and the second body portion 3, torque receiving portions 91 that support brake pads are provided. Further, the torque receiving portion 91 is provided with a clip mounting portion 9 (one example of a dent portion of the present invention) in a recessed shape to which a pad clip C1 (see an enlarged view in FIG. 6) that is connected to the ear portion of the brake pad, and fixes the brake pad to the caliper 1 is fixed. The mounting holes 7, the printed surface 8, the torque receiving portions 91 and the clip mounting portions 9, and the supply holes 77 described above are spots not needing electrostatic coating (corresponding to a region not needing powder of the present invention), where adhesion of a powder coating material is restrained, or the adhering powder coating material is removed, by a suction device 50 or an ejection device 60 that is provided in a coating device 10, when electrostatic coating is performed with the coating device 10. An effect of restraining adhesion of the powder coating material, or removing the adhering powder coating material is an effect that surpasses the conventional masking with a tape and a cap. The supply hole 77 is one example of an opening portion of the present invention. Note that a basic structure of the caliper 1 is similar to the caliper that is conventionally known, and therefore, detailed explanation will be omitted.

### Configuration of Powder Coating System

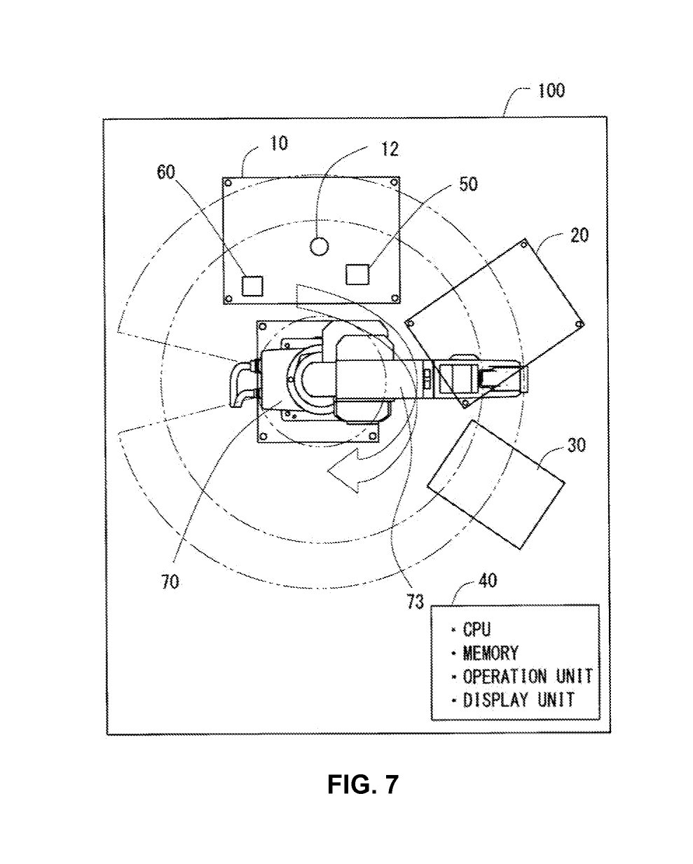

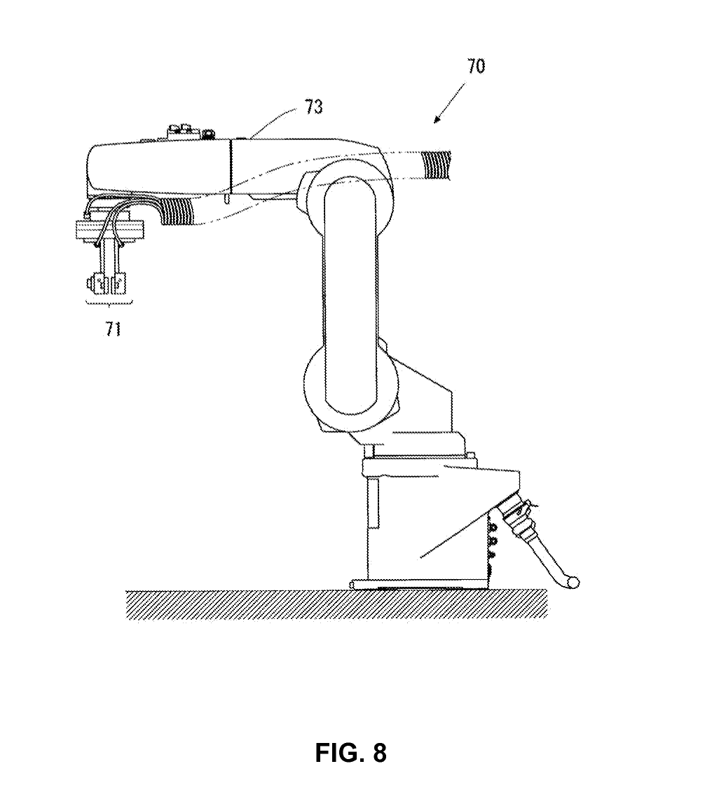

As illustrated in FIG. 7, a powder coating system 100 according to the embodiment (corresponding to a powder coating system of the present invention) includes a robot 70, the coating device 10, a heating device 20, a cooling device 30 and a control device 40. A powder coating auxiliary tool 80 (see FIG. 10) is attachable to a tip end portion of a robot arm 73 of the robot 70. Further, the coating device 10 is provided with the suction device 50 and the ejection device 60.

The robot 70 grasps the caliper body 1, and is movable three-dimensionally. The robot 70 according to the embodiment is an industrial machine that operates according to a teaching playback method, and is a so-called six-axis vertical articulated robot. The robot 70 preferably has six axes which has a high degree of freedom, but may have five axes or four axes. The robot 70 is automatically controlled by a CPU reading a program that is stored in a memory in advance. More specifically, the robot 70 performs grasp of the caliper 1, locomotion between devices (for example, locomotion to the heating device 20 from the coating device 10), change of an attitude of the caliper 1 in the respective devices, and the like.

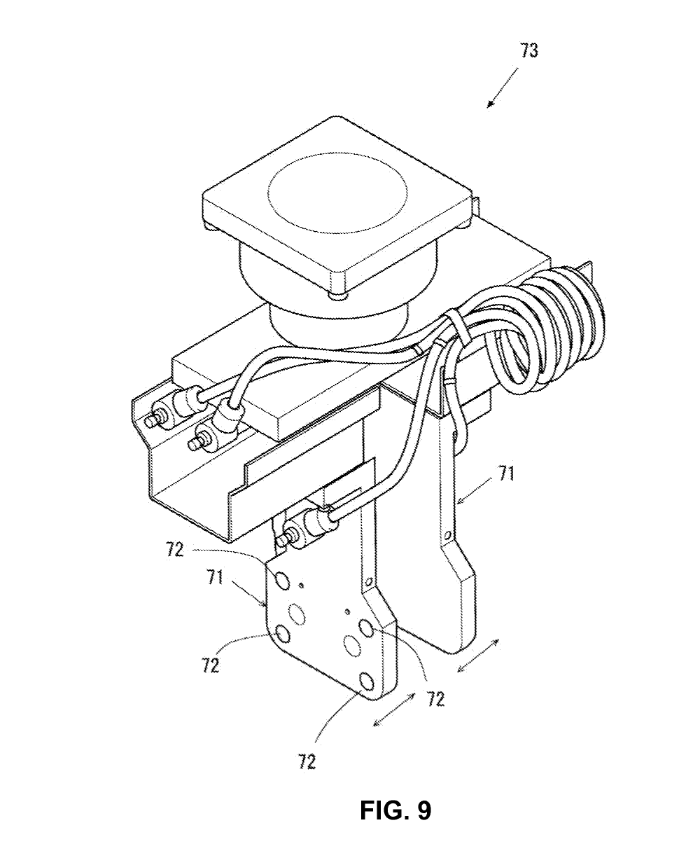

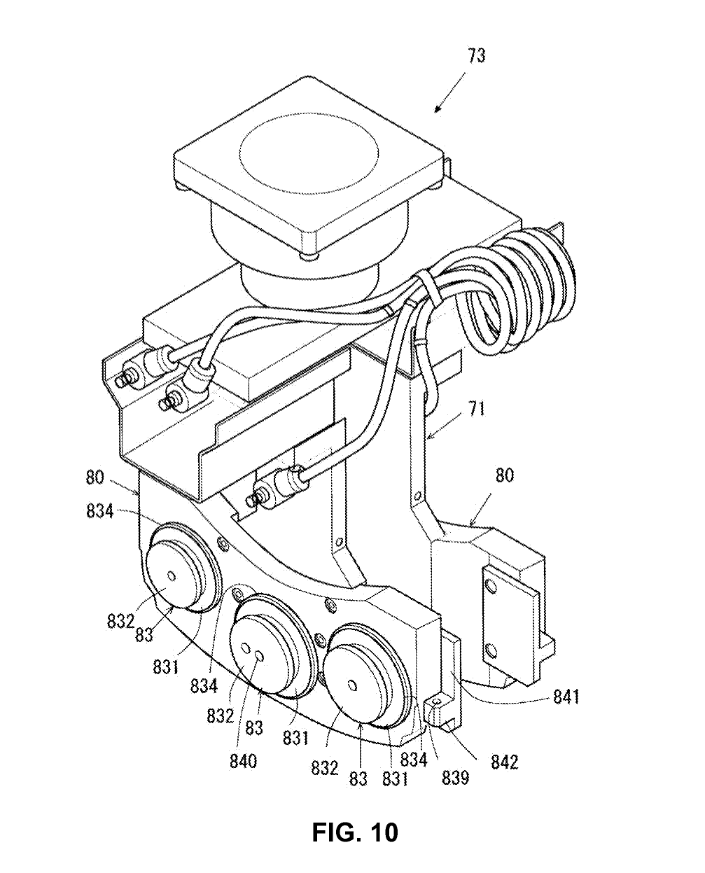

Here, FIG. 9 illustrates an enlarged view of the tip end portion of the robot arm 73 according to the embodiment. At the tip end portion of the robot arm 73, plate-shaped opposing grasping portions 71 are provided. The grasping portions 71 are movable in a direction perpendicular to the opposing surfaces, which is illustrated by the arrows in FIG. 9. In other words, the grasping portions 71 can freely change a distance from each other in a state in which the opposing surfaces are parallel with each other. Further, the grasping portion 71 is provided with a plurality of auxiliary tool fixing holes 72 that fix the powder coating auxiliary tool 80 (corresponding to a support tool of the present invention) which grasps the caliper 1. The auxiliary tool fixing holes 72 can be connected to the powder coating auxiliary tool 80 by burying magnets inside. For fixation of the powder coating auxiliary tool 80 to the grasping portion 71, other fixing methods that can freely detach the grasping portion 71 and the powder coating auxiliary tool 80, such as screwing, vacuum suction and clamps may be adopted. Further, an air supply path (not illustrated) that supplies air is provided in the grasping portion 71, and supply of air to the powder coating auxiliary tool 80 is enabled.

FIG. 10 illustrates a state in which the powder coating auxiliary tool 80 is fixed to the tip end portion of the robot arm 73 according to the embodiment. As illustrated in FIG. 10, the powder coating auxiliary tools 80 which grasp the caliper body 1 are fixed to surfaces (surfaces on sides opposite to the opposing surfaces) on outer sides of the grasping portions 71 at a tip end of the arm of the robot 70.

### Powder Coating Auxiliary Tool

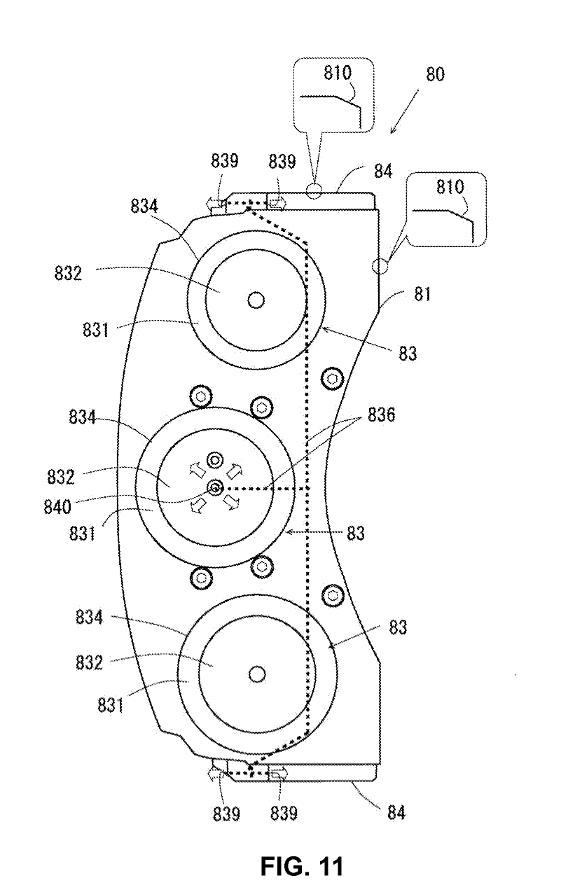

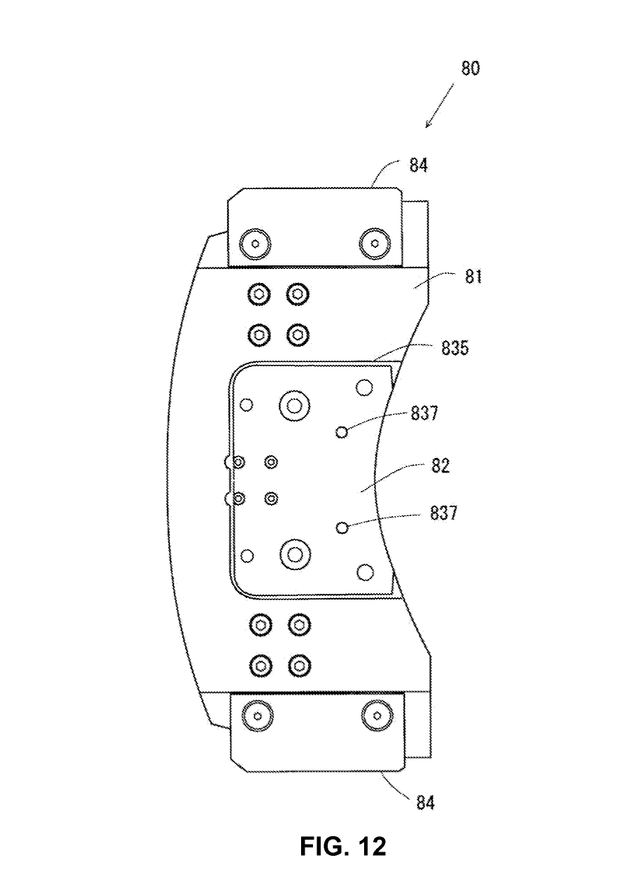

FIG. 11 illustrates a surface (a surface on a side in contact with the inner surface of the recessed portion 6 of the caliper 1) on an outer side of the powder coating auxiliary tool 80 according to the embodiment. FIG. 12 illustrates a surface on an inner side of the powder coating auxiliary tool according to the embodiment. The powder coating auxiliary tool 80 includes a main body portion 81 of an insulator in a slender plate shape, and a plate-shaped conducting portion 82 (see FIG. 12) that is fixed to an inner side surface of the main body portion 81. The powder coating auxiliary tool 80 is accommodated in the recessed portion 6 of the caliper 1, and therefore, is designed in accordance with a shape of the recessed portion 6. On a surface on an outer side of the main body portion 81, three circular protruded portions 83 that are fitted in the cylinders 5 of the caliper 1 are provided. The protruded portion 83 includes a large diameter portion 831 that is further protruded from an outer side surface of the main body portion 81, and a small diameter portion 832 that includes a diameter smaller than the large diameter portion 831 and is further protruded from the large diameter portion 831. An O-ring 834 that restrains entry of a powder coating material into the cylinder 5 is connected to an outer periphery of the large diameter portion 831. The small diameter portion 832 includes a circumferential edge formed into a taper shape in accordance with a shape of the cylinder 5. As illustrated in an enlarged view in FIG. 11, an inclined portion 810 of the main body portion may be formed at an edge of an outer side surface of the main body portion 81. The inclined portion 810 of the main body portion may be formed at a whole of the edge of the outer side surface of the main body portion 81, or may be formed at a part of the edge.

On the surface on the inner side of the main body portion 81, an accommodation portion 835 that accommodates the plate-shaped conducting portion 82 is provided. In the present embodiment, the protruded portion 83 which is located in a center, and the conducting portion 82 electrically continue to each other in the main body portion 81. Further, the grasping portion 71 of the robot 70 to which the conducting portion 82 is fixed is configured of steel, and functions as a ground. Accordingly, an electrified powder coating material is injected with the caliper 1 being grasped by the grasping portions 71 via the powder coating auxiliary tools 80, whereby the entire caliper 1 can be electrostatically coated. Further, the main body portion 81 is configured of a resin and is non-conductive, and therefore can restrain unneeded adhesion of the coating material. Further, the inclined portion 810 of the main body portion is formed at the edge of the outer side surface of the main body portion 81, whereby when the powder coating material is injected in a state in which the powder coating auxiliary tool 80 is accommodated in the recessed portion 6 of the caliper 1, the powder coating material advances into a gap that is formed between the inclined portion 810 of the main body portion and the inner surface of the recessed portion 6. Therefore, a film thickness of the powder coating material which adheres to the inner surface of the recessed portion 6 of the caliper 1 can be gradually formed to be thinner toward a region in contact with the main body portion 81. Note that the protruded portions 83 other than the protruded portion 83 which is located in a center, and the conducting portion 82 may be electrically continued to each other in the main body portion 81. Note that the powder coating auxiliary tool 80 can be adapted to calipers of various kinds and specifications by changing positions and sizes of the protruded portions 83.

Inside the powder coating auxiliary tool 80, an air passage 836 in which air passes (illustrated by the dotted lines in FIG. 11, and the arrows written in close proximity to end portions of the dotted lines indicate flows of air). In more detail, inlet ports 837 of the air passage are provided at two spots in a vicinity of a center of a long side of the main body portion 81 that is located at a base portion side of the grasping portion 71, at the inner side of the main body portion 81, as positions corresponding to outlet ports (not illustrated) of the air supply passage provided in the grasping portion 71 (see FIG. 12). The air passage 836 extends in a longitudinal direction to pass through the two inlet ports 837 in the main body portion 81, branches in a center, and extends in a short side direction to a central outlet port 840 provided in a center of the central protruded portion 83. Air that is ejected from the central outlet port 840 provided in the central protruded portion 83 passes through the other protruded portions 83 which communicate inside the caliper 1, and the supply holes 77 which communicate inside the caliper 1. As a result, at the time of coating, adhesion of the powder coating material to the inner side surfaces of all the cylinders 5, the supply holes 77, communication holes that cause the cylinders 5 to communicate with one another, and communication holes that cause the cylinders 5 and the supply holes 77 to communicate with one another is restrained. In this manner, the powder coating auxiliary tools 80 grasp the caliper 1, and also have a function of restraining adhesion of the powder coating material.

To both sides in the longitudinal direction of the main body portion 81, cover members 84 of an insulator that retrains adhesion of powder to the clip mounting portion 9 in the recessed shape of the caliper 1 are connected. Outlet ports of the air passage 836 which extends in the longitudinal direction are respectively provided at both sides in the longitudinal direction of the main body portion 81. The air passage 836 extending in the longitudinal direction extends to the cover members 84. The cover member 84 includes a plate-shaped base portion 841 that is connected to the inner side surface of the main body portion 81, and a protrudingly provided portion 842 that is orthogonal to both the side surfaces of the main body portion 81. The cover member 84 is also configured from a resin that is an insulator similarly to the main body portion 81. The air passage 836 which extends to the cover members 84 passes through the protrudingly provided portions 842, and extends to respective outlet ports 839 that are provided in opposing side surfaces (side surfaces in the short side direction of the main body portion 81) of the cover member 84. Air that is ejected from the respective outlet ports 839 restrains adhesion of the powder coating material to the inner side of the clip mounting portion 9 in the recessed shape. In a close vicinity to the respective outlet ports 839, in other words, in a vicinity of an inlet port of the clip mounting portion 9 in the recessed shape, adhesion of the powder coating material is restrained the most effectively. Meanwhile, the more away from the respective outlet ports 839, in other words, toward a back side of the clip mounting portion 9 in the recessed shape, the effect of restraining adhesion of the powder coating material becomes weaker. Therefore, a film thickness of the powder coating material which adheres to the inner surface of the clip mounting portion 9 in the recessed shape gradually becomes thinner toward the inlet port side from the back side (see FIG. 16). As a result, the powder coating material which adheres to the inner surface of the clip mounting portion 9 in the recessed shape also becomes difficult to peel off.

As illustrated in an enlarged view in FIG. 11, an inclined portion 840 of the cover member may be formed at an edge of an outer side surface of the cover member 84 of an insulator. The inclined portion 840 of the cover member may be formed at a whole of the edge of the outer side surface of the cover member 84, or may be formed at a part of the edge. By forming the inclined portion 840 of the cover member, the powder coating material advances into a gap that is formed between the inclined portion 840 of the cover member and an exposed surface of the torque receiving portion 91, when the powder coating material is injected in the state in which the powder coating auxiliary tool 80 is accommodated in the recessed portion 6 of the caliper 1. Therefore, the film thickness of the powder coating material which adheres to the exposed surface of the torque receiving portion 91 can be formed to be gradually thinner toward a region in contact with the cover member 84.

### Coating Device

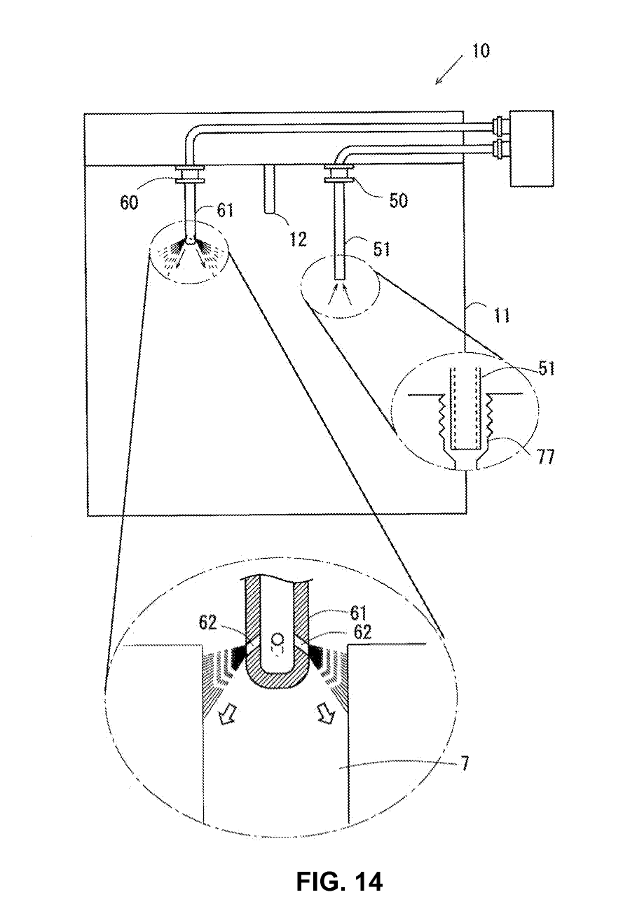

As illustrated in FIG. 7, the coating device 10 is installed within a movable range of the robot 70, and performs electrostatic coating of the caliper 1, and removal of coating on the region not needing coating, in the state in which the caliper 1 is grasped by the grasping portions 71 which are fixed to the tip end portion of the robot arm 73 of the robot 70. As illustrated in FIG. 14, the coating device 10 includes a coating nozzle 12 for an electrostatic coating material (a powder coating material) that is provided in a substantially center of a ceiling in a box 11, a suction device 50 and an ejection device 60 that are provided at a front side (a robot side) of the ceiling. The box 11 is opened at the front side, and the caliper 1 grasped by the robot 70 is capable of freely going in and out of the box 11. Note that the coating device 10 is provided with a dust collector (not illustrated) that sucks and collects the powder coating material in the box 11. The dust collector operates with suction strength that does not have an influence on coating at the time of coating, and sucks and collects the powder coating material in the box 11.

The coating nozzle 12 is connected to a tank that accommodates the powder coating material, a compressor and the like (not illustrated), and injects the electrified powder coating material downward. The coating nozzle 12 is electrically connected to the control device 40, and timing of injection of the powder coating material and an injection amount are controlled. The coating nozzle 12 is fixed to the ceiling of the box 11, and a whole of the caliper 1 is coated by three-dimensionally moving the robot arm 73 of the robot 70.

The suction device 50 sucks the powder coating material on the region not needing coating of the caliper 1 which is grasped by the grasping portions 71 which are fixed to the tip end portion of the robot arm 73 with a suction nozzle 51. An end portion of the suction nozzle 51 has a shape that is cut orthogonally to an axial direction of the nozzle. As the region not needing coating where the powder coating material is sucked by the suction device 50, the printed surface 8 of the caliper 1, bearing surfaces of the mounting holes 7, and the supply holes 77 are illustrated. For example, when the powder coating material in the supply hole 77 is sucked by the suction nozzle 51, a tip end of the suction nozzle 51 is inserted to a taper shoulder portion of the supply hole 77, and the powder coating material is sucked. The suction device 50 is electrically connected to the control device 40, and timing of suction and a suction force are controlled. The suction nozzle 51 is also fixed to the ceiling of the box 11, and sucks the powder coating material on the region not needing coating of the caliper 1 by moving the robot arm 73 three-dimensionally.

The ejection device 60 removes the powder coating material on the region not needing coating in the caliper 1 which is grasped by the grasping portions 71 which are fixed to the tip end portion of the robot arm 73 by ejection of air from an ejection nozzle 61. As the region not needing coating where the powder coating material is removed by the ejection device 60, the inner surface of the mounting hole 7 is illustrated. The ejection nozzle 61 according to the embodiment is provided with ejection ports 62 at sides in a nozzle tip end to be directed diagonally downward. As a result, when the ejection nozzle 61 is inserted into the mounting hole 7 and air is ejected, the powder coating material adhering to the inner surface of the mounting hole 7 is efficiently ejected outside, because the mounting hole 7 penetrates through the inside of the caliper 1. Note that an orientation of the ejection port 62 may be directed to a horizontal direction or diagonally upward instead of diagonally downward. The ejection device 60 is electrically connected to the control device 40, and timing for ejecting air and an ejection amount of air are controlled. The ejection nozzle 61 is fixed to the ceiling of the box 11, side by side with the suction nozzle 51, and removes the powder coating material on the region not needing coating of the caliper 1 by moving the robot arm 13 three-dimensionally.

### Heating Device

As illustrated in FIG. 7, the heating device 20 is installed within the movable range of the robot 70, and applies heat to the caliper 1 after being coated and having the powder coating material in the region not needing coating removed, which is conveyed by the robot 70, and bakes the powder coating material onto the caliper 1. The heating device 20 is electrically connected to the control device 40, and a heating temperature and a heating time period are controlled.

### Cooling Device

As illustrated in FIG. 7, the cooling device 30 is installed within the movable range of the robot 70, and cools the caliper 1 after heated, which is conveyed by the robot 70. The cooling device 30 is electrically connected to the control device 40, and a cooling temperature and a cooling time period are controlled.

### Control Device

As illustrated in FIG. 7, the control device 40 is electrically connected to the robot 70, the coating device 10, the suction device 50, the ejection device 60, the heating device 20 and the cooling device 30, and controls these devices. More specifically, the control device 40 includes a CPU, a memory, an operation unit, a display unit and the like, and controls the respective devices by the CPU executing a control program stored in the memory.

### Coating Method

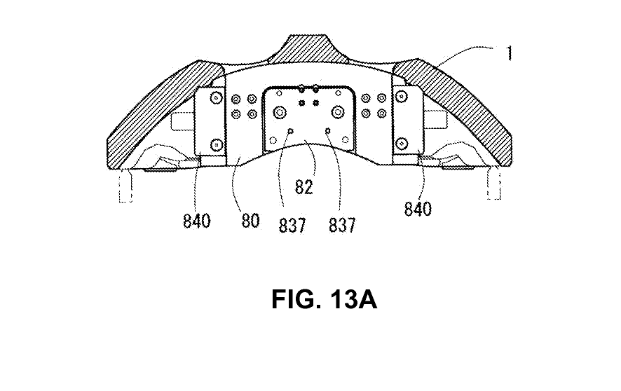

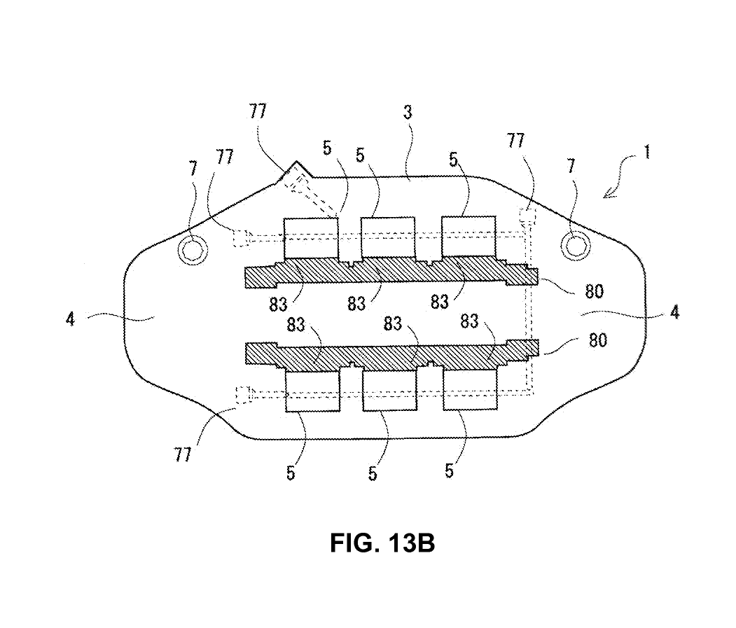

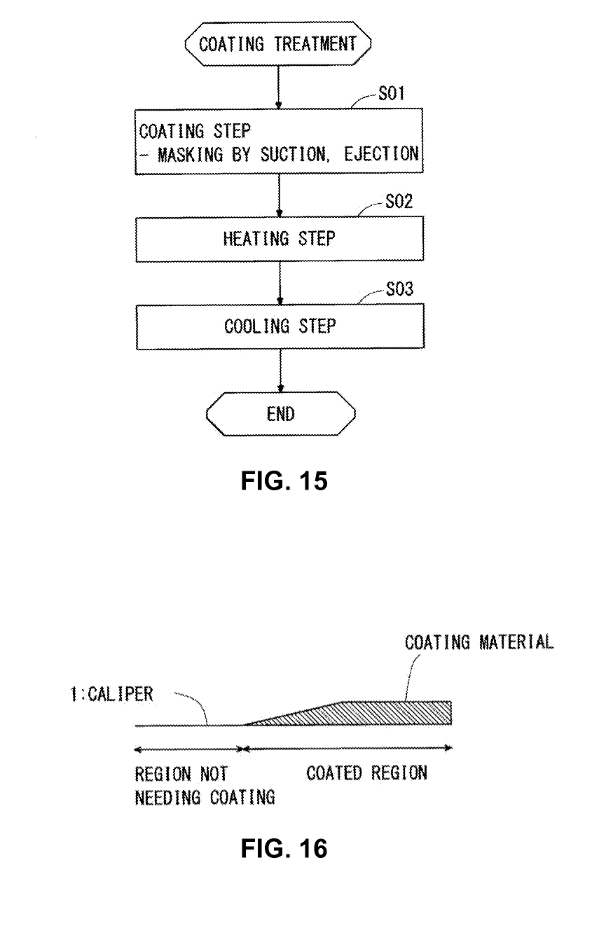

FIG. 15 illustrates a coating treatment flow according to the embodiment. Coating of the caliper 1 is started after conveyance of the cast caliper 1. In a coating step (step S01), coating of the caliper 1 and removal of the powder coating material in the region not needing coating are performed. More specifically, the robot 70 brings the distance between the powder coating auxiliary tools 80 which are fixed to the grasping portions 71 fixed to the tip end portion of the robot arm 73 to a distance that enables accommodation into the recessed portion 6, and causes the grasping portions 71 to advance into the recessed portion 6. Next, the robot 70 gradually enlarges the distance between the powder coating auxiliary tools 80, and fits the protruded portions 83 of the powder coating auxiliary tools into the cylinders 5 of the caliper 1 in a state in which airtightness is kept via the O-ring 834 (see FIG. 13B). As a result, the caliper 1 is grasped by the robot 70 in the state in which airtightness is kept. Next, the robot 70 moves the grasped caliper 1 to the coating device 10, and causes the caliper 1 to advance into the box 11. When the caliper 1 advances into the box 11, the coating nozzle 12 injects the electrified powder coating material. When the powder coating material is injected, the robot 70 three-dimensionally moves the grasped caliper 1 in the box 11. In response to injection of the powder coating material, the robot 70 supplied air into the air supply passage. As illustrated in FIG. 11, the supplied air passes through the air passage 836 and is ejected from the central outlet port 840 and the respective outlet ports 839. The air which is ejected from the central outlet port 840 passes through the other protruded portions 83 which communicate inside the caliper 1, and the supply holes 77 which communicate inside the caliper 1.

As a result, at the time of coating, adhesion of the powder coating material to the inner side surfaces of all the cylinders 5, the supply holes 77, the communication holes which allow the cylinders 5 to communicate with one another, and the communication holes which allow the cylinders 5 and the supply holes 77 to communicate with one another is restrained. Further, by the air which is ejected from the respective outlet ports 839, adhesion of the powder coating material to the inner surfaces of the clip mounting portions 9 in the recessed shapes is restrained. At this time, in the close vicinities of the respective outlet ports 839, adhesion of the powder coating material is restrained the most effectively, and the farther away from the respective outlet ports 839, the weaker the effect of restraining adhesion of the powder coating material becomes. Therefore, the film thickness of the powder coating material which adheres to the inner surface of the clip mounting portion 9 in the recessed shape becomes gradually thinner toward the inlet port side from the back side (see FIG. 16). As a result, the powder coating material which adheres to the inner surface of the clip mounting portion 9 in the recessed shape also becomes difficult to peel off. As above, by a positive pressure, adhesion of the powder coating material to the supply holes 77, and the clip mounting portions 9 is restrained. Further, the main body portion 81 is configured from a resin, and is non-conductive, and therefore, in the region in contact with the main body portion 81, of the recessed portion 6 of the caliper 1, adhesion of the powder coating material is restrained. Namely, irrespective of a positive pressure or a negative pressure, adhesion of the powder coating material is restrained. Further, in the case of the inclined portion 810 of the main body portion being formed at the edge of the outer side surface of the main body portion 81, when the powder coating material is injected in the state in which the powder coating auxiliary tool 80 is accommodated in the recessed portion 6 of the caliper 1, the powder coating material advances into the gap which is formed between the inclined portion 810 of the main body portion and the inner surface of the recessed portion 6 of the caliper 1. Therefore, the film thickness of the powder coating material which adheres to the inner surface of the recessed portion 6 of the caliper 1 can be formed to be gradually thinner toward the region which is in contact with the main body portion 81. Note that the exposed surface of the torque receiving portion 91 contacts the cover member 84 formed of an insulator, whereby adhesion of the powder coating material is restrained. Namely, adhesion of the powder coating material is restrained irrespective of a positive pressure or a negative pressure. Further, in the case of the inclined portion 840 of the cover member being formed at the edge of the outer side surface of the cover member 84 of an insulator, when the powder coating material is injected in the state in which the powder coating auxiliary tools 80 are accommodated in the recessed portion 6 of the caliper 1, the powder coating material advances into the gap which is formed between the inclined portion 840 of the cover member and the exposed surface of the torque receiving portion 91. Therefore, the film thickness of the powder coating material which adheres to the exposed surface of the torque receiving portion 91 can be formed to be gradually thinner toward the region which is in contact with the cover member 84.

Note that after start of injection of the powder coating material, the caliper 1 may be advanced into the box 11. When the three-dimensional movement in the box 11 which is programmed in advance is completed, the robot 70 moves the grasped caliper 1 to a close vicinity to the ejection nozzle 61.

Next, the robot 70 moves the grasped caliper 1 three-dimensionally so that the ejection nozzle 61 advances into the mounting hole 7. When the ejection nozzle 61 advances into the mounting hole 7, the ejection device 60 ejects air from the ejection nozzle 61, and removes the powder coating material adhering to the inner surface of the mounting hole 7. Namely, the powder coating material which adheres to the inner surface of the mounting hole 7 is removed by the positive pressure. The removed powder coating material is discharged from the opening portion (the inner side of the caliper 1) at a side opposite from the entry side of the ejection nozzle 61. When a plurality of mounting holes 7 are present, the robot 70 moves the grasped caliper 1 three-dimensionally, and causes the ejection nozzle 61 to advance into the mounting holes 7 in sequence. Next, the robot 70 moves the grasped caliper 1 to a close vicinity of the suction nozzle 51.

Next, the robot 70 moves the grasped caliper 1 three-dimensionally so that the end portion of the suction nozzle 51 is in a close vicinity to the region not needing coating. When the suction nozzle 51 approaches the region not needing coating, the suction device 50 starts suction by the suction nozzle 51, and removes the powder coating material adhering to the region not needing coating. Namely, the powder coating material is removed by the negative pressure. As the region not needing coating, the inner surface of the supply hole 77, the bearing surface of the mounting hole 7 and the printed surface 8 are illustrated. When a plurality of regions not needing coating are present, the robot 70 moves the grasped caliper 1 three-dimensionally, brings the suction nozzle 51 close to the regions not needing coating in sequence, and removes the powder coating material adhering to the regions not needing coating by suction. From the above, the coating step including masking is completed. By the above, the coating step including masking is completed. When the coating step is completed, the flow proceeds to a heating step.

In the heating step (step S02), the caliper 1 after electrostatic coating is baked. More specifically, the robot 70 moves the grasped caliper 1 to the heating device 20, and fixes the caliper 1 to a hanger of the heating device 20. When the caliper 1 is fixed to the hanger, the heating device 20 applies heat to the caliper 1 after electrostatic coating, and bakes the coating material to the caliper 1. When baking is completed, the robot 70 grasps the caliper 1 again. When the heating step is completed, the flow proceeds to a cooling step.

In the cooling step (step S03), the caliper 1 after heating is cooled. More specifically, the robot 70 moves the grasped caliper 1 after heating to the cooling device 30, and installs the caliper 1 in the cooling device 30. When the caliper 1 is accommodated in the cooling device 30, the cooling device 30 cools the caliper 1 after heating. When cooling is completed, the robot 70 grasps the caliper 1 again, and moves the caliper 1 to a conveyance place. By the above, electrostatic coating for the caliper 1 is completed. Thereafter, assembly of the brake pad, a piston, a clip C1 and the like to the caliper 1 is performed.

### Effect

According to the powder coating system 100 according to the embodiment described above, the caliper 1 is grasped by the powder coating auxiliary tools 80 which are fixed to the grasping portions 71 that are fixed to the tip end portion of the robot arm 73 of the robot 70 which is movably three-dimensionally, and the caliper 1 can be moved three-dimensionally. Therefore, while the caliper 1 is being grasped by the robot arm 73, electrostatic coating, restraint of adhesion of the powder coating material to the region not needing coating, removal of the powder coating material adhering to the region not needing coating can be performed. Further, since the caliper 1 itself is movable three-dimensionally, the caliper 1 does not need to be fixed again, or a plurality of suction devices 50, ejection devices 60, and the like do not need to be disposed around the caliper 1, irrespective of the shape of the caliper 1. Therefore, restraint of adhesion of the powder coating material to the region not needing coating, and removal of the powder coating material adhering to the region not needing coating can be performed more easily than the conventional art. Further, since three-dimensional movement of the caliper 1 is freely performed, a difference of the film thickness of the coated part and the film thickness of the region not needing coating can be gradually decreased as illustrated in FIG. 16. In other words, the film thickness can be made gradually thinner from the coated part toward the region not needing coating. Therefore, occurrence of coating removal and the like which is feared in the conventional masking by a plug and a tape can be restrained.

Further, the caliper 1 includes the recessed portion and the cylinders 5, the powder coating auxiliary tool 80 is accommodated in the recessed portion 6 of the caliper 1, and the protruded portions 83 are fitted into the cylinders 5, whereby the recessed portion 6 of the caliper 1 can be supported stably from inside. Further, air is supplied via the air passage 836 of the powder coating auxiliary tool 80, and air is ejected from the central outlet port 840, whereby at the time of coating, adhesion of the powder coating material to the inner side surfaces of all the cylinders 5, the supply holes 77, the communication holes that cause the cylinders 5 to communicate with one another, and the communication holes that cause the cylinders 5 and the supply holes 77 to communicate with one another is restrained. Further, air is supplied via the air passage 836, and the air is ejected from the respective outlet ports 839, whereby adhesion of the powder coating material to the inner surfaces of the clip mounting portions 9 in the recessed shapes can be restrained. At this time, in the close vicinities of the respective outlet ports 839, adhesion of the powder coating material is restrained the most effectively, and the farther away from the respective outlet ports 839, the more weaker the effect of restraining adhesion of the powder coating material. Therefore, the film thickness of the powder coating material which adheres to the inner surface of the clip mounting portion 9 in the recessed shape becomes gradually thinner toward the inlet port side from the back side (see FIG. 16). As a result, the powder coating material which adheres to the inner surface of the clip mounting portion 9 in the recessed shape becomes difficult to peel off.

Meanwhile, in the region in contact with the main body portion 81, of the recessed portion 6 of the caliper 1, adhesion of the powder coating material is restrained. Namely, irrespective of a positive pressure or a negative pressure, adhesion of the powder coating material is restrained. Further, when the inclined portion 810 of the main body portion is formed at the edge of the outer side surface of the main body portion 81, the powder coating material advances into the gap which is formed between the inclined portion 810 of the main body portion and the inner surface of the recessed portion 6 of the caliper 1. Therefore, the film thickness of the powder coating material adhering to the inner surface of the recessed portion 6 of the caliper 1 can be formed to be gradually thinner toward the region which is in contact with the main body portion 81. Further, the exposed surface of the torque receiving portion 91 contacts the cover member 84 which is formed of an insulator, whereby adhesion of the powder coating material is restrained. Namely, irrespective of a positive pressure or a negative pressure, adhesion of the powder coating material is restrained. Furthermore, when the inclined portion 840 of the cover member is formed at the edge of the outer side surface of the cover member 84 of an insulator, the powder coating material advances into the gap which is formed between the inclined portion 840 of the cover member and the exposed surface of the torque receiving portion 91. Therefore, the film thickness of the powder coating material adhering to the exposed surface of the torque receiving portion 91 can be formed to be gradually thinner toward the region which is in contact with the cover member 84. Like this, in the powder coating system 100 according to the embodiment, the insulator is brought into contact with the region not needing coating irrespective of a positive pressure, a negative pressure, or a positive pressure and a negative pressure, depending on the region, whereby restraint of adhesion of the powder coating material to the region not needing coating, and removal of the powder coating material adhering to the region not needing coating can be performed.

Note that various contents described above can be combined wherever possible within the range not departing from the technical idea of the present invention.

For example, in the powder coating auxiliary tool 80, the shapes, the number and the like of the protruded portions 83 can be properly changed in accordance with the caliper 1. The shapes and the number of the protruded portions 83 can be changed in accordance with the number of cylinders of the caliper 1 which is a coating target. For example, in the case of a so-called first type disk brake in which cylinders are present at the inner side, in the powder coating auxiliary tool 80, the protruded portions 83 are provided at the inner side, and the outer side can be formed into a planar shape. The powder coating auxiliary tool 80 also can be favorably used in other cast products to which coating is applied in optional colors.

Further, the coating device 10, the heating device 20 and the cooling device 30 can be within the movable range of the robot 70, and the disposition locations, the disposition sequence and the like can be properly changed. Further, pluralities of robots 70, coating devices 10, heating devices 20 and cooling devices 30 may be installed.

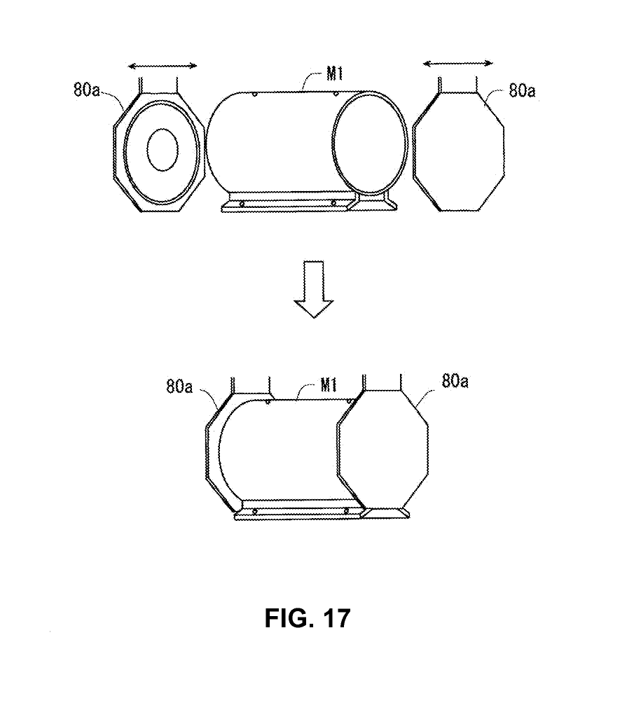

Further, the powder coating system 100 also can be used in other industrial products without being limited to a caliper by properly changing the shape and the size of the powder coating auxiliary tools 80. FIG. 17 illustrates a manner of grasping a motor case as the industrial product. A motor case M1 is in a cylindrical shape, can accommodate a motor inside, and includes cable holes that penetrate through an inside, in an upper part. Powder coating auxiliary portions 80a in plate shapes (hexagonal shapes in FIG. 17) having areas to cover two opening end portions of the motor case M1 like this are attached to an arm tip end of the robot 70, the motor case M1 is grasped in a state in which airtightness inside the motor case M1 is kept, and the inside is brought into a positive pressure, whereby adhesion of the powder coating material to the cable holes can be restrained.

### Another Embodiment

### Powder Coating Auxiliary Tool

In the aforementioned embodiment, the cover member 84 is configured from a resin that is an insulator similarly to the main body section 81 (see FIG. 11). On the other hand, the cover member 84 may be made of a metal. The cover member 84 contacts the torque receiving section 91 of the clip mounting section 9 in the recessed shape. Therefore, the cover member 84 may be made of metal. As a result, durability of the cover member 84 can be improved.

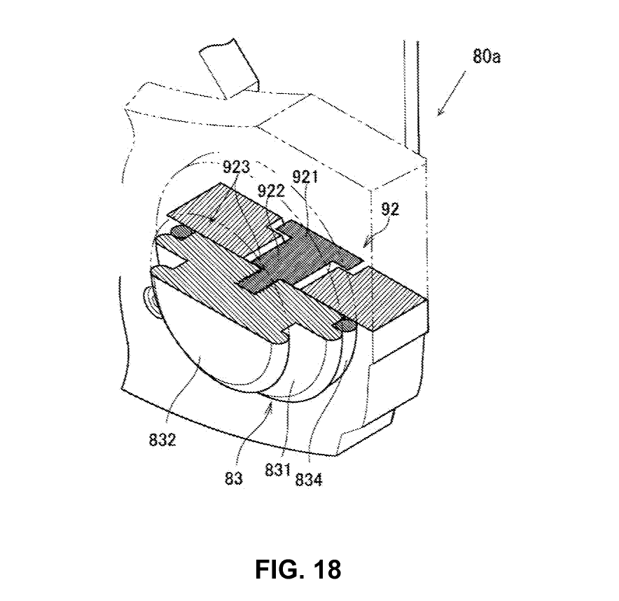

FIG. 18 illustrates a powder coating auxiliary tool according to another embodiment. FIG. 18 illustrates a state in which a powder coating auxiliary tool 80a according to the other embodiment to a tip end portion of the robot arm. In the powder coating auxiliary tool 80a according to the other embodiment, the protruded sections 83 other than the protruded section 83 which is located in the center are each fixed to the main body section 81 by a stepped bolt 92 having a step section 923 in a shaft section 922. The stepped bolt 92 is configured by a head section 921 and the shaft section 922. The shaft section 922 includes the step section 923, and a thread groove is formed on an outer circumferential surface of a tip end from the step section 923. The thread groove of the stepped bolt 92 is screwed into a thread groove on an inner circumferential surface of a threaded hole for the stepped bolt 92, which is formed in the protruded section 83. A gap is formed around the stepped bolt 92. Therefore, the protruded section 83 fixed by the stepped bolt 92 is movable within a range of the above described gap.

In the powder coating auxiliary tool 80a according to the other embodiment, illustrated in FIG. 18, the protruded sections 83 other than the protruded section 83 located in the center are each movable within a range of the gap formed around the stepped bolt 92. When the protruded sections 83 of the powder coating auxiliary tool are fitted into the cylinders 5 of the caliper 1, it is assumed that the protruded sections 83 contact the cylinders 5 of the caliper 1. Here, the protruded sections 83 other than the protruded section 83 which is located in the center are made movable within the ranges of the above described gaps, whereby the protruded sections 83 other than the protruded section 83 which is located in the center can be easily fitted into the cylinders 5 of the caliper 1, as compared with the case in which the protruded sections 83 do not move. As a result, the working efficiency can be more improved.

### Suction Coating Device

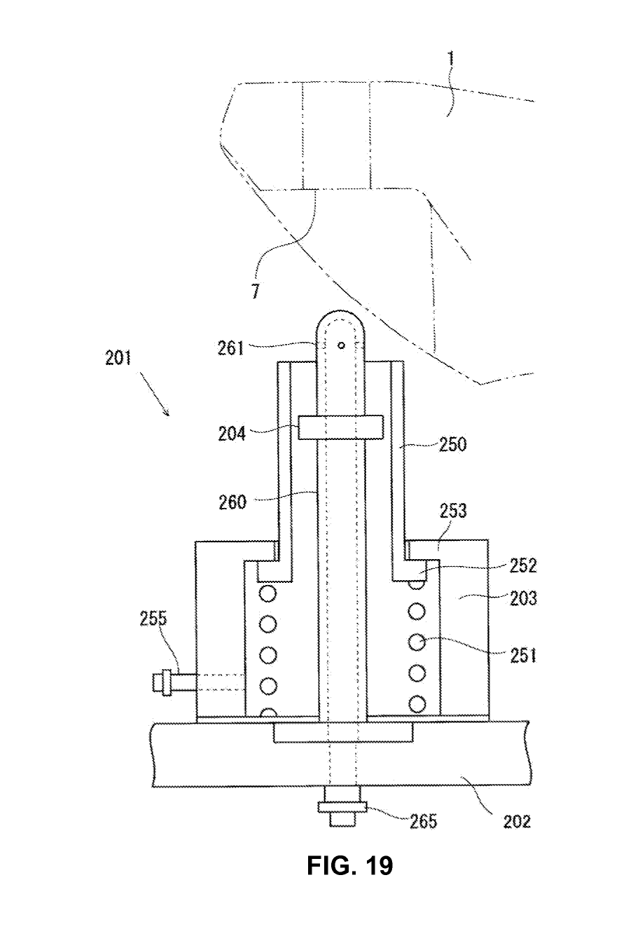

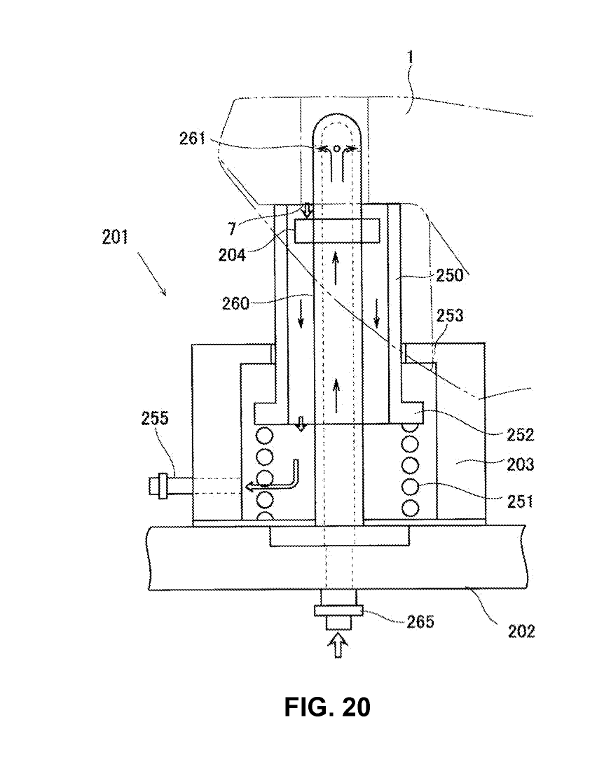

The coating device 10 according to the aforementioned embodiment has the configuration including the coating nozzle 12 for the electrostatic coating material (the powder coating material) which is provided in a substantially center of the ceiling in the box 11, and the suction device 50 and the ejection device 60 which are provided at the front side (the robot side) of the ceiling. Meanwhile, the coating device 10 may have a configuration including a suction ejection device 201 with an ejection shaft 260 and a suction collar 250 being integrated as illustrated in FIG. 19 and FIG. 20. Note that two of the suction ejection devices 201 can be disposed side by side so as to be able to remove the powder coating material adhering to the inner surfaces of the two mounting holes 7 which are formed in the caliper 1 at the same time. A space and the number of installed suction ejection devices 201 can be properly changed in accordance with the positions and the number of the mounting holes 7.

The suction ejection device 201 is disposed on a pedestal 202 so that a tip end points upward. The suction ejection device 201 includes the ejection shaft 260, the suction collar 250 and a fixing cylinder section 203.

The ejection shaft 260 is in an elongated cylindrical shape. The ejection shaft 260 has a length long enough to penetrate through the mounting hole 7 when the ejection shaft 260 is inserted into the mounting hole 7 of the caliper 1, for example. An air hose 265 that is connected to an air supply device (not illustrated) is connected to a base end of the ejection shaft 260, and supplied air flows upward in the ejection shaft 260. At sides of a tip end of the ejection shaft 260, four ejection ports 261 are formed radially to point sideward. Note that the ejection ports 261 may be formed to point diagonally upward or downward.

The suction collar 250 is in an elongated cylindrical shape with an inside diameter larger than an outside diameter of the ejection shaft 260. The suction collar 250 is formed to be shorter than the ejection shaft 260. The suction collar 250 is disposed to wrap the ejection shaft 260. Further, the suction collar 250 includes a spring 251 connected to a base end, and is configured to be slidable with respect to the ejection shaft 260, and to be able to return to a state before pressed (see FIG. 19) from a pressed state (see FIG. 20) by an urging force of the spring 251. The state before pressed is a state in which the spring 251 has a natural length, in other words, a state in which an external force is not applied to the suction collar 250. The pressed state is a state in which the spring 251 is contracted, in other words, a state in which the tip end of the suction collar 250 contacts the bearing surface of the mounting hole 7 of the caliper 1, for example, a downward force is applied to the suction collar 250, and the suction collar 250 is pressed downward. The base end of the suction collar 250 is provided with a stopper 252 that has an outside diameter formed to be larger than the other region, and prevents removal from the fixing cylinder section 203.

At a position near to the tip end of the ejection shaft 260 and corresponding to the tip end of the suction collar 250, a ring 204 for regulating a flow rate and flow velocity at a time of suction is provided. An outside diameter of the ring 204 is formed to be smaller than an inside diameter of the suction collar 250. Therefore, a gap is formed between an inner wall of the suction collar 250 and an outer wall of the ring 204. Air which is sucked passes through the gap, whereby the flow velocity of the air which is sucked can be increased, and a sufficient suction force can be obtained. Note that the outside diameter and the length of the ring 204 are properly adjusted, whereby the flow velocity and the flow rate of the air which is sucked can be regulated.

The fixing cylinder section 203 is fixed to the pedestal 202. The fixing cylinder section 203 has an inside diameter formed to be slightly larger than the outside diameter of the suction collar 250, and supports the suction collar 250 slidably. In a vicinity of a center of the fixing cylinder section 203, a stopper receiving section 253 which is formed of a step that engages with the stopper 252 is provided, and is configured to be able to prevent removal of the suction collar 250. Further, a suction hose 255 that discharges sucked air is connected to a side surface of a lower portion of the fixing cylinder section 203.

Explaining an operation, the robot 70 moves the grasped caliper 1 three-dimensionally so that the recessed section 6 of the caliper 1 opens upward so that the tip end of the ejection shaft 260 of the suction ejection device 201 advances into the mounting hole 7. When the ejection shaft 260 advances into the mounting hole 7, the suction ejection device 201 ejects air from the ejection shaft 260, and removes the powder coating material adhering to the inner surface of the mounting hole 7. Further, the suction ejection device 201 starts suction by the suction collar 250, and sucks powder coating material adhering to the bearing surface of the mounting hole 7 and the powder coating material removed by the air ejected from the ejection shaft 260. The air containing the sucked powder coating material ensures a sufficient flow velocity by passing through the gap formed between the inner wall of the suction collar 250 and the outer wall of the ring 204, thereafter advances downward through the space between the inner wall of the suction collar 250 and the outer wall of the ejection shaft 260, and is discharged outside via the suction hose 255. The robot 70 gradually moves the grasped caliper 1 downward. As a result, the tip end of the suction collar 250 contacts the bearing surface of the mounting hole 7, and the suction collar 250 is pressed in downward. When the ejection ports 261 in the tip end of the ejection shaft 260 penetrates through the mounting hole 7, the robot 70 gradually moves the grasped caliper 1 upward. As a result, the ejection shaft 260 which advances into the mounting hole 7 retreats from the inside of the mounting hole 7.

The suction ejection device 201 according to the other embodiment can remove the powder coating material adhering to the inside of the mounting hole 7 formed in the caliper 1, and the powder coating material adhering to the bearing surface of the mounting hole 7 at the same time. Furthermore, in the suction ejection device 201 according to the other embodiment, the ejection ports 261 of the ejection shaft 260 penetrate through the mounting hole 7, the ejected air is ejected to point sideway, and the powder coating material which is removed by the air from the ejection shaft 260 is sucked by the suction collar 250. Therefore, the powder coating material does not accumulate in the port section or the like of the mounting hole 7, and the powder coating material can be reliably removed. Further, by including the ring 204, a sufficient suction force can be ensured. By the above, working efficiency is improved, and a high-quality product to which an unneeded coating material does not adhere can be provided. Note that the suction ejection device 201 also may be used for removal of the coating material adhering to the inner surfaces of the other holes such as an oil hole. Further, by installing a plurality of suction ejection devices 201 according to the other embodiment, the powder coating materials which adhere to the insides of the holes at a plurality of places can be removed at the same time.

### Coating Device

The suction nozzle 51 of the suction device 50 described above has the shape in which the end portion is cut orthogonally to the axial direction of the nozzle. Further, as the region not needing coating where the powder coating material is sucked, the printed surface 8 of the caliper 1, the bearing surface of the mounting hole 7, and the supply hole 77 are illustrated. Meanwhile, the shape of the tip end of the suction nozzle 51 may be changed in accordance with the region not needing coating.

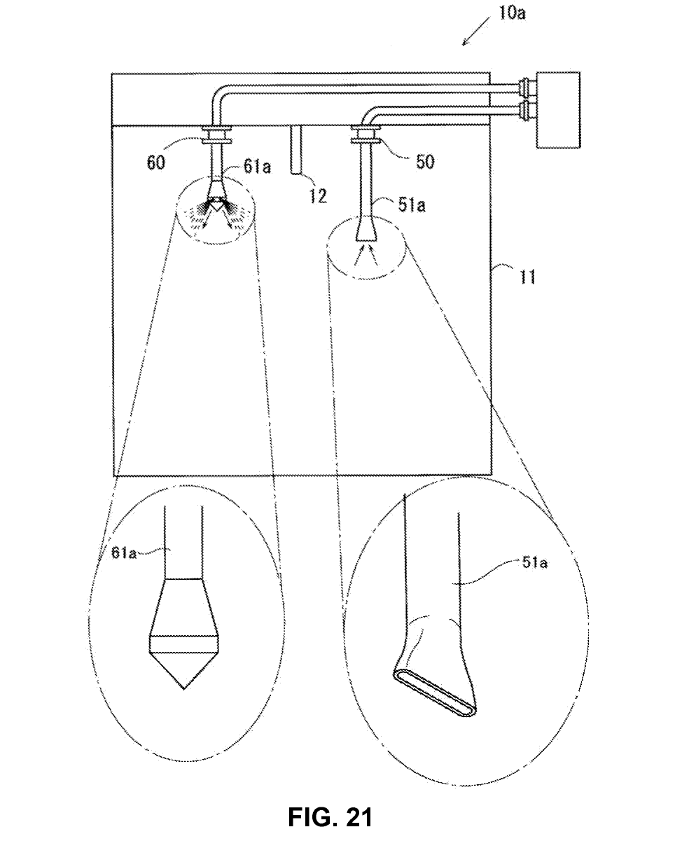

FIG. 21 illustrates a coating device according to another embodiment. In a coating device 10a according to the other embodiment illustrated in FIG. 21, a tip end shape of a suction nozzle 51 a of the suction device 50 differs from the tip end shape of the suction nozzle 51 according to the aforementioned embodiment. Further, in the coating device 10a according to the other embodiment illustrated in FIG. 21, a tip end shape of an ejection nozzle 61 a of the ejection device 60 differs from the tip end shape of the ejection nozzle 61 according to the aforementioned embodiment.

The suction nozzle 51a of the suction device 50 illustrated in FIG. 21 sucks a powder coating material adhering to a flat surface such as the printed surface 8 of the caliper 1. The tip end shape of the suction nozzle 51 a according to the other embodiment is a flat shape. Therefore, as compared with the case in which the tip end of the suction nozzle 51 a is circular, the flow velocity at the time of suction is increased, and the powder coating material on a wide area can be sucked at one time. Namely, according to the suction nozzle 51a of the suction device 50 illustrated in FIG. 21, the powder coating material which adheres to the flat surface like the printed surface 8 of the caliper 1 can be sucked efficiently.

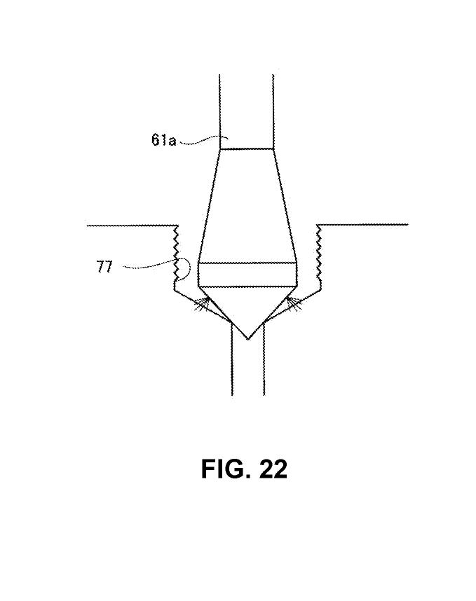

Further, the ejection nozzle 61a of the ejection device 60 illustrated in FIG. 21 removes the powder coating material adhering to the inner surface of the supply hole 77 of the caliper 1, for example, by a positive pressure. In the ejection nozzle 61 a according to the other embodiment, the tip end is in a conical shape. A conical portion of the tip end is formed to be larger than a diameter of a communication hole connected to an inner part of the supply hole 77, and closes an inner portion of the supply hole 77, in other words, an inlet of the communication hole. Further, as illustrated in FIG. 22, in the conical portion, ejection ports are formed to point diagonally downward, and are configured to be able to eject air diagonally downward.

Explaining an operation, the robot 70 moves the grasped caliper 1 three-dimensionally so that the tip end of the ejection nozzle 61a of the ejection device 60 closes the inner portion of the supply hole 77, in other words, the inlet of the communication hole. When the tip end of the ejection nozzle 61a of the ejection device 60 closes the inner portion of the supply hole 77, in other words, the inlet of the communication hole, the ejection device 60 ejects air from the ejection nozzle 61a, and removes the powder coating material adhering to the inner surface of the supply hole 77.

### Others

Further, the powder coating material adhering to the robot arm 73 can be removed by ejecting air from the ejection nozzle 61 of the ejection device 60, and moving the robot arm 73, for example. Further, the powder coating material adhering to the robot arm 73 may be removed by providing an air curtain at the ceiling of the box 11, for example. By providing the air curtain, the powder coating material adhering to the robot arm 73 can be removed more efficiently. As a result, the working efficiency can be more improved.

### REFERENCE SIGNS LIST

1 . . . Caliper

2 . . . First body section

3 . . . Second body section

4 . . . Connecting section

5 . . . Cylinder

6 . . . Recessed section

7 . . . Mounting hole

9 . . . Clip mounting section

10 . . . Coating device

11 . . . Box

12 . . . Coating nozzle

20 . . . Heating device

30 . . . Cooling device

40 . . . Control device

50 . . . Suction device

51 . . . Suction nozzle

70 . . . Robot

73 . . . Robot arm

71 . . . Grasping section

77 . . . Supply hole

80 . . . Powder coating auxiliary tool

81 . . . Main body section

83 . . . Protruded section

84 . . . Cover member

91 . . . Torque receiving section

C1 . . . Pad clip

836 . . . Air passage

1. A powder coating system that attaches powder to a workpiece, comprising:
a support tool that supports the workpiece;
a robot arm that has the support tool fixed thereto, and is movable three-dimensionally; and
a removing device that restrains adhesion of powder to a region not needing powder in the workpiece supported by the support tool fixed to the robot arm, or removes powder adhering to a powder adhering region, by at least either one of ejection or suction.

2. The powder coating system according to claim 1, wherein the removing device includes at least any one of
a first ejection device that restrains adhesion of powder to the region not needing powder, by ejection of air,
a second ejection device that removes powder adhering to the region not needing powder, by ejection of air, and
a suction device that removes powder adhering to the region not needing powder, by suction.

3. The powder coating system according to claim 1,
wherein the removing device includes a first ejection device that restrains adhesion of powder to the region not needing powder, by ejection of air,
the workpiece includes an opening portion, and a recessed section that communicates with the opening portion,
the support tool supports the recessed section of the workpiece from inside, and includes, in an inside, an air passage in which air passes, and
the first ejection device ejects air via the air passage of the support tool, and restrains adhesion of powder to an inner surface of the opening portion, from inside of the workpiece.

4. The powder coating system according to claim 1,
wherein the support tool includes a fitting section that is fitted to a part of the recessed section of the workpiece in a hermetic state,
the fitting section is configured by a conductive member and is electrically grounded, and
the workpiece has powder electrostatically attached thereto in an electrically grounded state.

5. The powder coating system according to claim 1,
wherein the removing device includes a second ejection device that removes powder adhering to the region not needing powder, by ejection of air, and
the second ejection device inserts an ejection nozzle into an opening portion of the workpiece to eject air, and removes powder adhering to an inner surface of the opening portion of the workpiece.

6. The powder coating system according to claim 1, wherein the removing device includes a suction ejection device that removes powder adhering to the region not needing powder by suction, and removes the powder adhering to the region not needing powder by ejection of air.

7. The powder coating system according to claim 1, further comprising:
a powder coating device that attaches powder to the workpiece, and includes the removing device; and
a heating device that bakes the powder which is attached to the workpiece, to the workpiece,
wherein the powder coating device and the heating device are disposed within a range where the robot arm is movable.

8. The powder coating system according to claim 1,
wherein the workpiece is a caliper for a brake, and a cylinder is provided at a part of the recessed section of the workpiece.

9. A powder coating method that attaches powder to a workpiece, comprising: a powder removing step of supporting the workpiece by a support tool that is fixed to a tip end portion of a robot arm which is three-dimensionally movable, and supports the workpiece, and restraining adhesion of powder to a region not needing powder in the workpiece supported by the support tool fixed to the tip end portion of the robot arm, or removing powder adhering to a powder adhering region, by at least either one of ejection or suction.

10. The powder coating method according to claim 9, further comprising:
a powder coating step of attaching powder to the workpiece; and
a heating step of heating the workpiece to which the powder is attached,
wherein the powder coating step, the powder removing step, and the heating step are performed in a state in which the workpiece is fixed to the robot arm via the support tool, by moving the robot arm three-dimensionally.

11. A production method of a caliper, comprising:
a powder coating step of supporting the caliper by a support tool that supports the caliper fixed to a tip end portion of a robot arm which is movable three-dimensionally, and attaching powder to the caliper;
a powder removing step of restraining adhesion of powder to a region not needing powder of the caliper supported by the support tool, and removing powder adhering to a powder adhering region, by at least either one of ejection or suction;
a heating step of baking the powder which is attached to the caliper, to the caliper; and
a cooling step of cooling the caliper to which the powder is baked.

12. A caliper produced by the powder coating system according to claim 1.

13. The caliper according to claim 12, wherein in the caliper, a film thickness is formed to be gradually thinner toward a region not needing powder from a powder adhering region.
